(19) United States
(12) Patent Application Publication
(10) Pub. No.: US 2022/0232382 A1
(43) Pub. Date: Jul. 21, 2022

(54) CONTROLLING PROVISION OF ACCESS TO RESTRICTED LOCAL OPERATOR SERVICES BY USER EQUIPMENT

(71) Applicant: Nokia Technologies Oy, Espoo (FI)

(72) Inventor: Suresh NAIR, Whippany, NJ (US)

(21) Appl. No.: 17/617,817

(22) PCT Filed: May 20, 2020
(86) PCT No.: PCT/IB2020/000386

§ 371 Date: Dec. 9, 2021

Related U.S. Application Data
(60) Provisional application No. 62/861,700, filed on Jun. 14, 2019.

(51) Int. Cl. H04W 12/08; H04W 12/06

(52) U.S. Cl. CPC H04W 12/08; H04W 12/06

(57) ABSTRACT

Improved techniques are provided for security management in communication systems particularly with respect to access to restricted local operator services in the case of roaming user devices. In one example in accordance with user equipment in a communication system, a method includes initiating a request for access to restricted local operator services, acquiring a network identifier comprising a first country code, and comparing the acquired network identifier with a stored network identifier comprising a second country code. A determination is made whether the first country code and the second country code are different. At least a first action is performed in response to an affirmative determination, and at least a second action is performed in response to a negative determination.

### FIELD

The field relates generally to communication systems, and more particularly, but not exclusively, to security management within such systems.

### BACKGROUND

This section introduces aspects that may be helpful in facilitating a better understanding of the inventions. Accordingly, the statements of this section are to be read in this light and are not to be understood as admissions about what is in the prior art or what is not in the prior art.

Fourth generation (4G) wireless mobile telecommunications technology, also known as Long Term Evolution (LTE) technology, was designed to provide high capacity mobile multimedia with high data rates particularly for human interaction. Next generation or fifth generation (5G) technology is intended to be used not only for human interaction, but also for machine type communications in so-called Internet of Things (IoT) networks.

While 5G networks are intended to enable massive IoT services (e.g., very large numbers of limited capacity devices) and mission-critical IoT services (e.g., requiring high reliability), improvements over legacy mobile communication services are supported in the form of enhanced mobile broadband (eMBB) services providing improved wireless Internet access for mobile devices.

In an example communication system, user equipment (5G UE in a 5G network or, more broadly, a UE) such as a mobile terminal (subscriber) communicates over an air interface with a base station or access point of an access network referred to as a 5G AN in a 5G network. The access point (e.g., gNB or Non-3GPP InterWorking Function (N3IWF) or Trusted Non3GPP Gateway (TNGF) or Wireline Access Gateway Function (W-AGF) depending on the type of 5G Access Network: supporting New Radio (NR) radio defined by 3GPP, supporting an Untrusted Non 3GPP access to 5GC, supporting Trusted Non 3GPP access to 5G Core (5GC) or supporting a Wireline access to 5GC) is illustratively part of an access network of the communication system. For example, in a 5G network, the access network is referred to as a 5G AN and is described in 5G Technical Specification (TS) 23.501, V16.0.2, entitled “Technical Specification Group Services and System Aspects; System Architecture for the 5G System,” the disclosure of which is incorporated by reference herein in its entirety. In general, the access point (e.g., gNB or N3IWF or TNGF or W-AGF depending on the type of 5G Access Network) provides access for the UE to a core network (CN or 5GC), which then provides access for the UE to other UEs and/or a data network such as a packet data network (e.g., Internet).

TS 23.501 goes on to define a 5G Service-Based Architecture (SBA) which models services as network functions (NFs) that communicate with each other using representational state transfer application programming interfaces (Restful APIs).

Furthermore, 5G Technical Specification (TS) 33.501, V15.4.0, entitled “Technical Specification Group Services and System Aspects; Security Architecture and Procedures for the 5G System,” the disclosure of which is incorporated by reference herein in its entirety, further describes security management details associated with a 5G network.

Security management is an important consideration in any communication system. For example, security of communications when a roaming UE is requesting restricted access to a Public Land Mobile Network (PLMN) is one example where security management is an issue. Security of such communications presents several challenges in existing 5G approaches.

### SUMMARY

Illustrative embodiments provide improved techniques for security management in communication systems particularly with respect to network access by roaming user equipment. More particularly, one or more illustrative embodiments use Mobile Country Codes (MCCs) to provide communication security for non-subscriber user equipment seeking restricted local access to mobile networks.

For example, in one illustrative embodiment in accordance with user equipment, a method comprises initiating a request for access to restricted local operator services, acquiring a network identifier comprising a first country code, and comparing the acquired network identifier with a stored network identifier comprising a second country code. A determination is made whether the first country code and the second country code are different. At least a first action is performed in response to an affirmative determination, and at least a second action is performed in response to a negative determination.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 illustrates a communication system with which one or more illustrative embodiments are implemented.

FIG. 2 illustrates processing architectures for user equipment and network nodes, according to an illustrative embodiment.

FIG. 3 illustrates methodology for user equipment acquiring master and system information blocks from a network, according to an illustrative embodiment.

FIG. 4 is a flow diagram illustrating a part of a methodology to provide security for user equipment seeking restricted local access to mobile networks, according to an illustrative embodiment.

FIG. 5 is a flow diagram illustrating another part of a methodology to provide security for user equipment seeking restricted local access to mobile networks, according to an illustrative embodiment.

### DETAILED DESCRIPTION

Embodiments will be illustrated herein in conjunction with example communication systems and associated techniques for providing security (e.g., for user equipment seeking restricted local access to mobile networks) in communication systems. It should be understood, however, that the scope of the claims is not limited to particular types of communication systems and/or processes disclosed. Embodiments can be implemented in a wide variety of other types of communication systems, using alternative processes and operations. For example, although illustrated in the context of wireless cellular systems utilizing 3GPP system elements such as a 3GPP next generation system (5G), the disclosed embodiments can be adapted in a straightforward manner to a variety of other types of communication systems.

In accordance with illustrative embodiments implemented in a 5G communication system environment, one or more 3GPP technical specifications (TS) and technical reports (TR) provide further explanation of user equipment and network nodes (e.g., network elements/functions) and/or operations that interact with one or more illustrative embodiments, e.g., the above-referenced 3GPP TS 23.501 and 3GPP TS 33.501. Other 3GPP TS/TR documents provide other conventional details that one of ordinary skill in the art will realize. However, while illustrative embodiments are well-suited for implementation associated with the above-mentioned 5G-related 3GPP standards, alternative embodiments are not necessarily intended to be limited to any particular standards.

Furthermore, illustrative embodiments will be explained herein in the context of the Open Systems Interconnection model (OSI model) which is a model that conceptually characterizes communication functions of a communication system such as, for example, a 5G network. The OSI model is typically conceptualized as a hierarchical stack with a given layer serving the layer above and being served by the layer below. Typically, the OSI model comprises seven layers with the top layer of the stack being the application layer (layer 7) followed by the presentation layer (layer 6), the session layer (layer 5), the transport layer (layer 4), the network layer (layer 3), the data link layer (layer 2), and the physical layer (layer 1). One of ordinary skill in the art will appreciate the functions and interworkings of the various layers and, thus, further details of each layer are not described herein. However, it is to be appreciated that while illustrative embodiments are well-suited for implementations that utilize an OSI model, alternative embodiments are not necessarily limited to any particular communication function model.

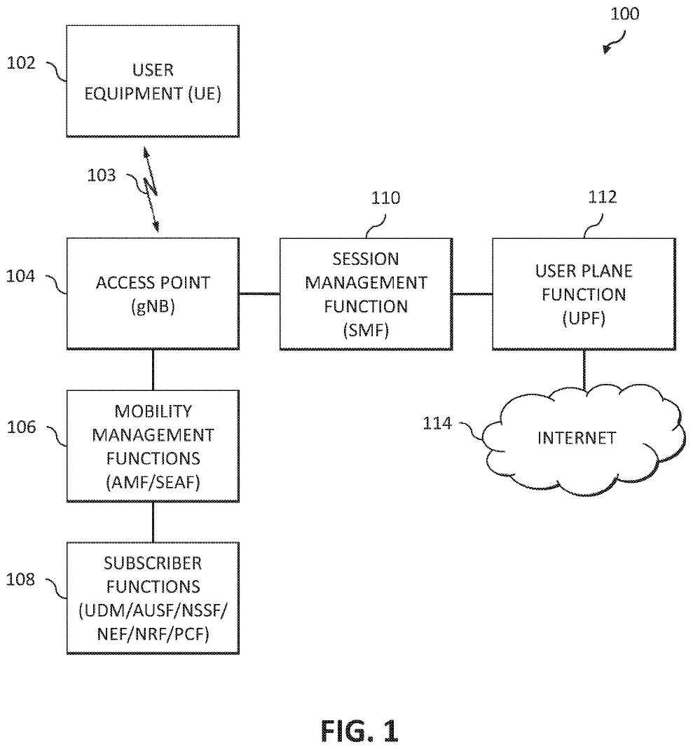

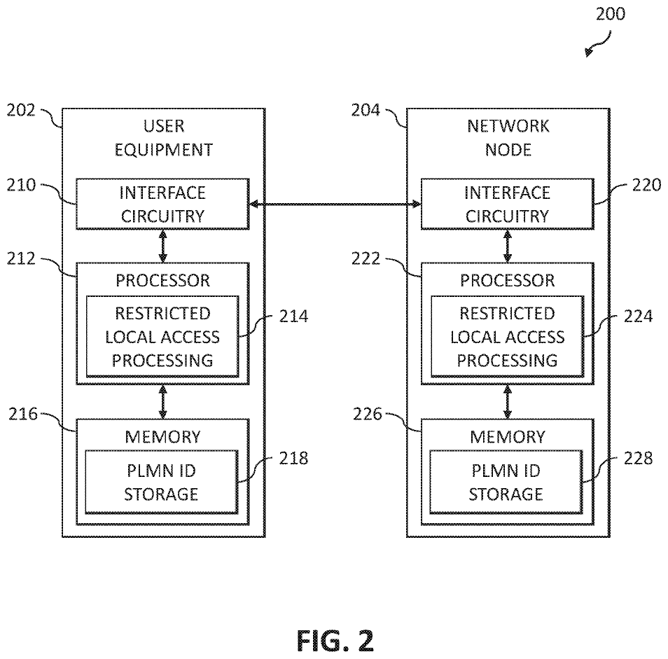

Illustrative embodiments are related to management of non-subscriber user equipment seeking restricted network access associated with the Service-Based Architecture (SBA) for 5G networks. Prior to describing such illustrative embodiments, a general description of main components of a 5G network will be described below in the context of FIGS. 1 and 2.

FIG. 1 shows a communication system 100 within which illustrative embodiments are implemented. It is to be understood that the elements shown in communication system 100 are intended to represent main functions provided within the system, e.g., UE access functions, mobility management functions, authentication functions, serving gateway functions, etc. As such, the blocks shown in FIG. 1 reference specific elements in 5G networks that provide these main functions. However, other network elements may be used in other embodiments to implement some or all of the main functions represented. Also, it is to be understood that not all functions of a 5G network are depicted in FIG. 1. Rather, functions that facilitate an explanation of illustrative embodiments are represented. Subsequent figures may depict some additional elements/functions.

Accordingly, as shown, communication system 100 comprises user equipment (UE) 102 that communicates via an air interface 103 with an access point 104 (gNB or N3IWF or TNGF or W-AGF depending on the type of 5G Access Network). The UE 102 in some embodiments is a mobile station, and such a mobile station may comprise, by way of example, a mobile telephone, a computer, or any other type of communication device. The term “user equipment” as used herein is therefore intended to be construed broadly, so as to encompass a variety of different types of mobile stations, subscriber stations or, more generally, communication devices, including examples such as a combination of a data card inserted in a laptop or other equipment such as a smart phone or other cellular device. In one or more illustrative embodiments, user equipment refers to an IoT device. Such communication devices are also intended to encompass devices commonly referred to as access terminals. In other embodiments, the UE could be hosted by a Residential Gateway connected to 5G Core via Wireline access.

In one embodiment, UE 102 is comprised of a Universal Integrated Circuit Card (UICC) part and a Mobile Equipment (ME) part. The UICC is the user-dependent part of the UE and contains at least one Universal Subscriber Identity Module (USIM) and appropriate application software. The USIM securely stores the permanent subscription identifier and its related key, which are used to identify and authenticate subscribers to access networks. The ME is the user-independent part of the UE and contains terminal equipment (TE) functions and various mobile termination (MT) functions. The UICC may be a physical card, such as a smart card configured for insertion into a smart card slot of the ME. The UICC may alternatively be an embedded UICC (eUICC).

Note that, in one example, the permanent subscription identifier is an International Mobile Subscriber Identity (IMSI) of a UE. In one embodiment, the IMSI is a fixed 15-digit length and consists of a 3-digit Mobile Country Code (MCC), a 3-digit Mobile Network Code (MNC), and a 9-digit Mobile Station Identification Number (MSIN). In a 5G communication system, an IMSI is referred to as a Subscription Permanent Identifier (SUPI). In the case of an IMSI as a SUPI, the MSIN provides the subscriber identity. Thus, only the MSIN portion of the IMSI typically needs to be encrypted. The MNC and MCC portions of the IMSI provide routing information, used by the serving network to route to the correct home network. When the MSIN of a SUPI is encrypted, it is referred to as a Subscription Concealed Identifier (SUCI).

The access point 104 is illustratively part of an access network of the communication system 100. Such an access network comprises, for example, a 5G System having a plurality of base stations and one or more associated radio network control functions. The base stations and radio network control functions in some embodiments are logically separate entities, but in some embodiments are implemented in the same physical network element, such as, for example, a base station router or cellular access point.

The access point 104 in this illustrative embodiment is operatively coupled to mobility management functions 106. In a 5G network, the mobility management function is implemented by an Access and Mobility Management Function (AMF). A Security Anchor Function (SEAF) in some embodiments is also implemented with the AMF connecting a UE with the mobility management function. A mobility management function, as used herein, is the element or function (i.e., entity) in the core network (CN) part of the communication system that manages or otherwise participates in, among other network operations, access and mobility (including authentication/authorization) operations with the UE (through the access point 104). The AMF is also referred to herein, more generally, as an access and mobility management entity.

The AMF 106 in this illustrative embodiment is operatively coupled to subscriber functions 108, i.e., one or more functions that are resident in the home network of the subscriber or elsewhere. As shown, some of these functions include the Unified Data Management (UDM) function, as well as an Authentication Server Function (AUSF). The AUSF and UDM (separately or collectively) are also referred to herein, more generally, as an authentication entity. In addition, subscriber functions include, but are not limited to, Network Slice Selection Function (NSSF), Network Exposure Function (NEF), Network Repository Function (NRF), and Policy Control Function (PCF).

A “third party” is meant to refer to a party other than the subscriber of the UE or the operator of the core network. For example, in one or more illustrative embodiments, the third party is an enterprise (e.g., corporation, business, group, individual, or the like). In some embodiments, the subscriber of the UE is an employee of the enterprise (or otherwise affiliated) who maintains a mobile subscription with the operator of the core network or another mobile network. Note that a UE associated with a subscription is typically subscribed to what is referred to as a Home Public Land Mobile Network (HPLMN) in which some or all of the subscriber functions 108 reside. If the UE is roaming (not in the HPLMN) and/or without a subscription to a PLMN, it is typically connected with a Visited Public Land Mobile Network (VPLMN) also referred to as a serving network. Some or all of the mobility management functions 106 may reside in the VPLMN, in which case, functions in the VPLMN communicate with functions in the HPLMN as needed. However, in a non-roaming scenario, mobility management functions 106 and subscriber functions 108 can reside in the same communication network or elsewhere.

The access point 104 is also operatively coupled to a serving gateway function, i.e., Session Management Function (SMF) 110, which is operatively coupled to a User Plane Function (UPF) 112. UPF 112 is operatively coupled to a Packet Data Network (PDN), e.g., Internet 114. As is known in 5G and other communication networks, the user plane (UP) or data plane carries network user traffic while the control plane (CP) carries signaling traffic. SMF 110 supports functionalities relating to UP subscriber sessions, e.g., establishment, modification and release of Protocol Data Unit (PDU) sessions. UPF 112 supports functionalities to facilitate UP operations, e.g., packet routing and forwarding, interconnection to the data network (e.g., 114 in FIG. 1), policy enforcement, and data buffering.

It is to be appreciated that FIG. 1 is a simplified illustration in that not all communication links and connections between network functions (NFs) and other system elements are illustrated in FIG. 1. One ordinarily skilled in the art given the various 3GPP TSs/TRs will appreciate the various links and connections not expressly shown or that may otherwise be generalized in FIG. 1.

Further typical operations and functions of certain network elements are not described herein in detail when they are not the focus of illustrative embodiments but can be found in appropriate 3GPP 5G documentation. It is to be appreciated that the particular arrangement of system elements in FIG. 1 is an example only, and other types and arrangements of additional or alternative elements can be used to implement a communication system in other embodiments. For example, in other embodiments, the system 100 comprises other elements/functions not expressly shown herein. Also, although only single elements/functions are shown in the FIG. 1 embodiment, this is for simplicity and clarity of illustration only. A given alternative embodiment may include larger numbers of such system elements, as well as additional or alternative elements of a type commonly associated with conventional system implementations.

It is also to be noted that while FIG. 1 illustrates system elements as singular functional blocks, the various subnetworks that make up the 5G network are partitioned into so-called network slices. Network slices (network partitions) comprise a series of network function (NF) sets (i.e., function chains) for each corresponding service type using network function virtualization (NFV) on a common physical infrastructure. The network slices are instantiated as needed for a given service, e.g., eMBB service, massive IoT service, and mission-critical IoT service. A network slice or function is thus instantiated when an instance of that network slice or function is created. In some embodiments, this involves installing or otherwise running the network slice or function on one or more host devices of the underlying physical infrastructure. UE 102 is configured to access one or more of these services via access point 104 (gNB or N3IWF or TNGF or W-AGF depending on the type of 5G Access Network). NFs can also access services of other NFs.

Illustrative embodiments provide a methodology for using MCCs to provide communication security for non-subscriber user equipment seeking restricted local access to mobile networks. As noted above, if the UE is roaming (not in the HPLMN) and/or without a subscription to a PLMN, it is typically connected with a VPLMN (serving network). As described further herein, the embodiments correspond to roaming UEs attempting to access a serving network, such as a VPLMN.

FIG. 2 is a block diagram of processing architectures 200 of user equipment 202 and a network node 204 (e.g., a network function participant) in a methodology for providing access to restricted local services in an illustrative embodiment. As will be further explained below, more than two participants are involved in the methodology according to illustrative embodiments, e.g., UE, AMF, NEF, and AUSF. For example, network functions may be provided by combinations of participants where mobility management functions 106 and subscriber functions 108 reside. FIG. 2 illustrates processing architectures associated with user equipment 202 and a network node 204 that directly or indirectly communicate. In illustrative embodiments, each participant in the methodology for providing access to restricted local services is understood to be configured with the same or similar processing architecture shown in FIG. 2.

As shown, user equipment 202 comprises a processor 212 coupled to a memory 216 and interface circuitry 210. The processor 212 of the user equipment 202 includes a restricted local access processing module 214 that may be implemented at least in part in the form of software executed by the processor 212. The processing module 214 performs functions associated with providing communication security for non-subscriber user equipment seeking restricted local access to serving networks described in conjunction with subsequent figures and otherwise herein. The memory 216 of the user equipment 202 includes a PLMN Identity (PLMN ID) storage module 218 that stores identity information for a PLMN. As described further herein, the PLMN identity information is acquired by user equipment 202 when the user equipment 202 is powered on, performs a network search, and receives network information. In an illustrative embodiment, the PLMN ID includes, for example, the MCC and MNC used by a network, such as a serving network.

As further shown, a network node 204 comprises a processor 222 coupled to a memory 226 and interface circuitry 220. The processor 222 of the network node 204 includes a restricted local access processing module 224 that may be implemented at least in part in the form of software executed by the processor 222. The processing module 224 performs functions associated with providing communication security for non-subscriber user equipment seeking restricted local access to serving networks described in conjunction with subsequent figures and otherwise herein. The memory 226 of the network node 204 includes a PLMN ID storage module 228 that stores identity information for a PLMN.

The processors 212 and 222 of the user equipment 202 and network node 204 may comprise, for example, microprocessors, application-specific integrated circuits (ASICs), field programmable gate arrays (FPGAs), digital signal processors (DSPs) or other types of processing devices or integrated circuits, as well as portions or combinations of such elements. Such integrated circuit devices, as well as portions or combinations thereof, are examples of “circuitry” as that term is used herein. A wide variety of other arrangements of hardware and associated software or firmware may be used in implementing the illustrative embodiments.

The memories 216 and 226 of the user equipment 202 and network node 204 may be used to store one or more software programs that are executed by the respective processors 212 and 222 to implement at least a portion of the functionality described herein. For example, functions associated with providing communication security for non-subscriber user equipment seeking restricted local access to serving networks and other functionality as described in conjunction with subsequent figures and otherwise herein may be implemented in a straightforward manner using software code executed by processors 212 and 222.

A given one of the memories 216 or 226 may therefore be viewed as an example of what is more generally referred to herein as a computer program product or still more generally as a processor-readable storage medium that has executable program code embodied therein. Other examples of processor-readable storage media may include disks or other types of magnetic or optical media, in any combination. Illustrative embodiments can include articles of manufacture comprising such computer program products or other processor-readable storage media.

The memory 216 or 226 may more particularly comprise, for example, an electronic random-access memory (RAM) such as static RAM (SRAM), dynamic RAM (DRAM) or other types of volatile or non-volatile electronic memory. The latter may include, for example, non-volatile memories such as flash memory, magnetic RAM (MRAM), phase-change RAM (PC-RAM) or ferroelectric RAM (FRAM). The term “memory” as used herein is intended to be broadly construed, and may additionally or alternatively encompass, for example, a read-only memory (ROM), a disk-based memory, or other type of storage device, as well as portions or combinations of such devices.

The interface circuitries 210 and 220 of the user equipment 202 and network node 204 illustratively comprise transceivers or other communication hardware or firmware that allows the associated system elements to communicate with one another in the manner described herein.

It is apparent from FIG. 2 that the user equipment 202 is configured for communication with the network node 204 and vice-versa via their respective interface circuitries 210 and 220. This communication involves the user equipment 202 sending data to the network node 204, and the network node 204 sending data to the user equipment 202. However, in alternative embodiments, other network elements or other components may be operatively coupled between, as well as to, the user equipment 202 and network node 204. The term “data” as used herein is intended to be construed broadly, so as to encompass any type of information that may be sent between user equipment and network nodes including, but not limited to, messages, tokens, identifiers, keys, indicators, user data, control data, etc.

It is to be appreciated that the particular arrangement of components shown in FIG. 2 is an example only, and numerous alternative configurations are used in other embodiments. For example, any given network element/function, or more generally any given network node, can be configured to incorporate additional or alternative components and to support other communication protocols.

Given the above illustrative architectures, illustrative embodiments of methodologies for using MCCs to provide communication security for non-subscriber user equipment seeking restricted local access to mobile networks will be further described below. Prior to such descriptions, some main drawbacks that at least partially motivated development of illustrative embodiments will be described in the context of a 5G network.

Restricted Local Operator Services (RLOS), which may also be referred to as Provision of Access to Restricted Local Operator Services (PARLOS), supports incoming roaming UEs who do not have a pre-existing subscription with a PLMN. Such incoming UEs are provided with what is referred to as manual roaming, where the UE links with serving network (e.g. VPLMN) via a manual roaming service provider's interactive voice response (IVR). Once financial payment information, such as a prepaid account or credit card is validated via the IVR, the UE will be able to place a call for a small fee. The small fee is typically charged to a payment mechanism provided by a user associated with the UE.

Manual roaming is an FCC obligation on operators in the United States (U.S.). More specifically, manual roaming is a requirement that U.S. networks must provide basic outbound only voice calling for users with a UE capable of connecting to a network's base stations (e.g., supporting the same bandclass), when there is no roaming agreement with the PLMN operator. Since there is no pre-existing subscription agreement between the PLMN and the user associated with the UE, and the PLMN is expected to offer RLOS restricted services without authenticating the UE, only application level security can be set up between the RLOS server and the UE.

To enable services entered via RLOS, the serving PLMN may request certain personal information from a user, such as, for example, name, address, location and payment information. Without adequate protection, the personal information may be intercepted by third parties who may use the personal information for fraudulent purposes. Hence, transfer of personal information over unprotected communication links is a security threat in offering RLOS services.

In 3GPP TR 33.815, V0.5.0, entitled “Technical Specification Group Services and System Aspects; Security Aspects; Study on Security Aspects of PARLOS,” the disclosure of which is incorporated by reference herein in its entirety, key issues for security aspects related to the PARLOS service are identified, threats related to the issues are defined, and a solution is proposed. The solution relies on a UE providing a public key to the serving network, which is used by the serving network to encrypt a K_{ASME} that will be used to protect traffic between the UE and serving network. The solution provides confidentiality and integrity protection for the non-access stratum (NAS) and access stratum (AS) signaling against passive attacks (e.g., if an attacker is eavesdropping on data being exchanged between the UE and network), but not against active attacks (e.g., an attacker is operating as a false base station). Additional details regarding RLOS are described in Annex J of 3GPP TS 33.401 v16.2.0, the disclosure of which is incorporated by reference herein in its entirety.

In countries where RLOS manual roaming does not exist and/or is not a requirement or regulated, UEs may undesirably connect to a fake base station and network, as a result of the fake base station advertising a PLMN ID (e.g., MCC+MNC) belonging to a country where RLOS is required to be supported (e.g., U.S.). For example, an MNC from one of the PLMN operators, which is public knowledge and broadcasted by networks, could be reused by a fake base station. Therefore, even though a particular country does not support the legal use of a RLOS feature, an attacker, by using a fake base station, may be able to succeed in making the UE connect to the fake base station. By offering RLOS service, and manual roaming, the fake base station could extract critical personal information such as, for example, name and credit card information, which can be misused. Hence, there is a need to prevent the unwanted connection of a UE to fake base stations, which broadcast trusted PLMN IDs (e.g., MCCs+MNCs) belonging to another country where RLOS is required and where the fake base station is not located.

Illustrative embodiments provide a new methodology for preventing a UE from connecting to a false base station, thus preventing active attacks to obtain sensitive personal information from a user of the UE. Illustrative embodiments provide a mechanism to prevent scenarios where a UE recognizes and selects a PLMN of one country, while the UE is actually in another.

In accordance with one or more embodiments, features of the methodology to provide communication security for non-subscriber user equipment seeking restricted local access to mobile networks may include:

1. The user of a device (e.g., UE), through a user interface, affirmatively invokes the RLOS feature, so that the UE is not automatically initiating a RLOS connection, or connecting to a fake base station in an unauthorized jurisdiction.

2. A requirement that a user, through a user interface, affirmatively confirms the country, city and/or other geographic identifier representing the user's (and UE's) current location each time a user invokes the RLOS feature, so that the UE does not connect with a spurious RLOS server or a fake RLOS site identified as being from another country.

3. Detecting a change of PLMN ID by the UE from a stored PLMN ID in the UE, and requesting from a user, through a user interface, manual confirmation of the country and/or MCC where the UE is operating.

4. A UE will not change a currently designated and/or stored PLMN ID associated with a first country to a PLMN ID associated with another country until the UE is powered off and on or enters and exits airplane mode. In other words, a UE will change the PLMN ID or MCC only if it enters and exits airplane mode, or upon being powered on from a power off state.

UE implementations, in accordance with one or more embodiments, ensure that a UE will not automatically select and connect to a PLMN which advertises an MCC which is different from the actual country where the UE is physically present.

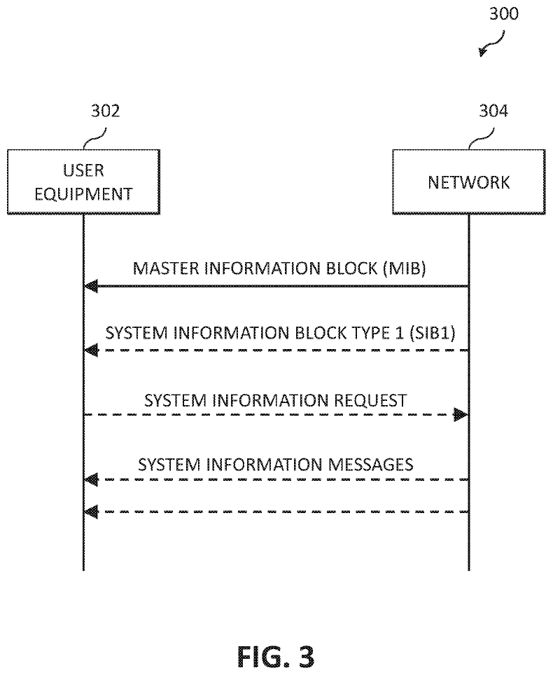

Referring to FIG. 3, a methodology 300 for user equipment 302 acquiring master and system information blocks from a network 304 is shown. For example, typically user equipment 302 shall apply a system information (SI) acquisition procedure upon cell selection (e.g. upon power on), cell-reselection, return from out of coverage (e.g., exiting airplane mode), after reconfiguration with sync completion, after entering the network from another radio access technology (RAT), upon receiving an indication that the system information has changed, upon receiving a public warning system (PWS) notification, and whenever the UE does not have a valid version of a stored system information block (SIB). The SI acquisition procedure may include transmission of a System Information Request from the user equipment 302 to the network 304 (e.g., a PLMN), and the provision of a master information block (MIB), SIB and System Information Messages from the network 304 to the user equipment 302. The user equipment 302 can acquire SI from a periodic broadcast of SI by the network 304 or by sending the SI request to a base station. A network broadcasts a PLMN ID, which contains, for example, an MCC and an MNC. The MCC could be extracted from a PLMN ID or extracted from a response to the SI request.

For example, when the user equipment 302 acquires an MIB, SIB Type 1 (SIB1) and/or an SI message in a serving cell from the network 304, the user equipment 302 stores the acquired SIB1. The user equipment 302 may also store the associated areaScope, if present, the first PLMN-Identity in the PLMN-IdentityInfoList, the cellIdentity, the systemInformationAreaID, if present, and the valueTag, if present, as indicated in the si-SchedulingInfo for the SIB.

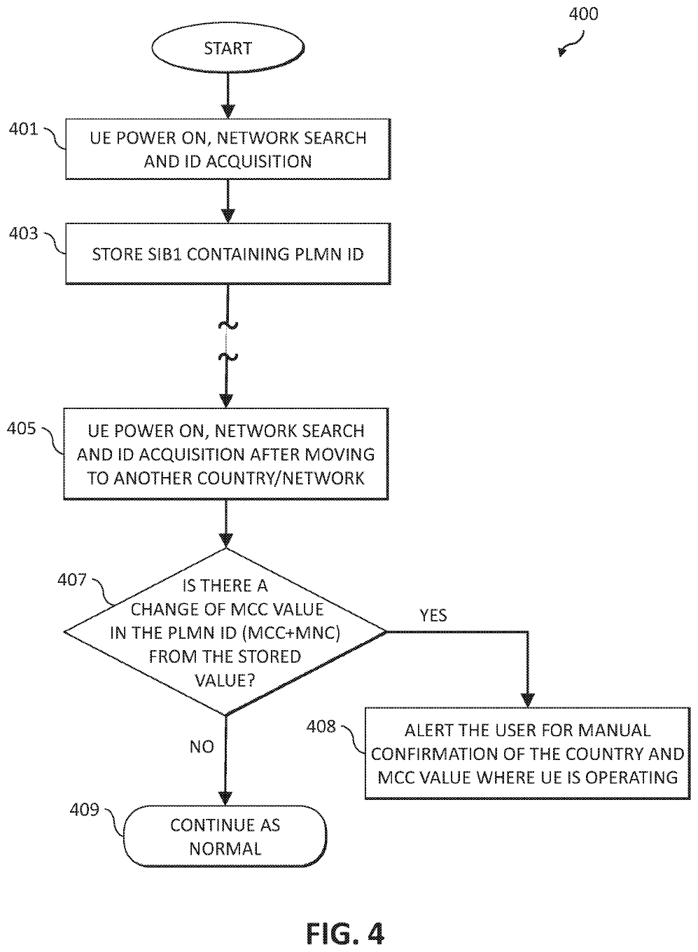

FIG. 4 is a flow diagram 400 illustrating a part of a methodology to provide security for user equipment seeking restricted local access to mobile networks, according to an illustrative embodiment. Referring to block 401, user equipment applies an SI acquisition procedure upon powering on, where a network search is performed and a network identifier such as a PLMN ID contained in an SIB1 is acquired by the user equipment from the network. At block 403, the SIB1 including the PLMN ID is stored in a memory of the user equipment. According to an illustrative embodiment, the PLMN ID includes an MCC and an MNC.

Referring to block 405, after being powered off and powered back on again, returning to coverage (e.g., after entering and exiting airplane mode), or after moving to another country and/or network, the user equipment applies another SI acquisition procedure, where a network search is performed and a network identifier such as a PLMN ID contained in an SIB1 is acquired by the user equipment from the network. At block 407, the newly acquired PLMN ID, also including an MCC and an MNC, is compared with the stored PLMN ID to determine whether there is a difference from the stored PLMN ID. If there is a difference, as per block 408, a user of the user equipment is alerted of the difference, and prompted for manual confirmation via, for example, a user interface on the user equipment, of the country in which the user equipment is currently located, and/or the MCC value. If the country confirmed by the user matches with the MCC in the newly acquired PLMN ID, then the user equipment may conclude that the PLMN ID is authentic (e.g., not from a fake base station using a false country code), store the newly acquired PLMN ID to replace the previously stored PLMN ID, and permit access to restricted local operator services. If the country confirmed by the user does not match with the MCC in the newly acquired PLMN ID, then the user equipment may conclude that the PLMN ID is not authentic (e.g., from a fake base station using a false country code), maintain the previously stored PLMN ID, and deny access to restricted local operator services.

If there is no difference between the stored PLMN ID and the newly acquired PLMN ID, normal operation continues as per block 409.

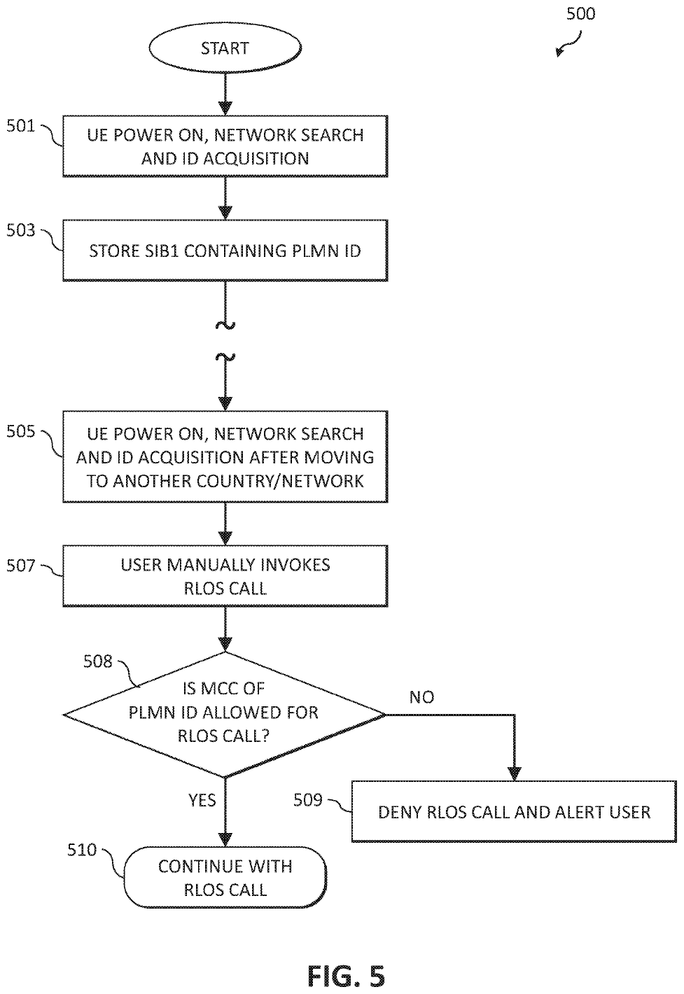

FIG. 5 is a flow diagram 500 illustrating another part of a methodology to provide security for user equipment seeking restricted local access to mobile networks, according to an illustrative embodiment. Referring to blocks 501, 503 and 505, similar to blocks 401, 403 and 405 in FIG. 4, user equipment in block 501 applies an SI acquisition procedure upon powering on, where a network search is performed and a network identifier such as a PLMN ID contained in an SIB1 is acquired by the user equipment from the network. The SIB1 including the PLMN ID is stored in a memory of the user equipment in block 503. After being powered off and powered back on again, returning to coverage (e.g., after entering and exiting airplane mode), or after moving to another country and/or network, the user equipment applies another SI acquisition procedure in block 505, where a network search is performed and a network identifier such as a PLMN ID contained in an SIB1 is acquired by the user equipment from the network.

At block 507, a user of the user equipment manually invokes a RLOS call through, for example, a user interface of the user equipment. According to an embodiment, the user equipment may require affirmative invocation of RLOS feature to prevent the user equipment from automatically initiating a RLOS connection without user review, and to avoid connecting to a fake base station in an unauthorized jurisdiction. The requirement of affirmatively invoking RLOS features provides an added layer of protection not currently available.

Similar to block 407, at block 508, a newly acquired PLMN ID, also including an MCC and an MNC, is compared with the stored PLMN ID to determine whether there is a difference from the stored PLMN ID. If there is a difference, as per block 509, the RLOS procedure is terminated, access to restricted local operator services is denied, and a user of the user equipment is alerted of the difference and denial of RLOS services. In the case of a difference, the user equipment may conclude that the PLMN ID is not authentic (e.g., from a fake base station using a false country code) and maintain the previously stored PLMN ID.

If there is no difference between the stored PLMN ID and the newly acquired PLMN ID, the user equipment allows the RLOS procedure to continue as per block 510, and a call may be placed using restricted local operator services.

The particular processing operations and other system functionality described in conjunction with the diagrams of FIGS. 3-5 are presented by way of illustrative example only, and should not be construed as limiting the scope of the disclosure in any way. Alternative embodiments can use other types of processing operations and messaging protocols. For example, the ordering of the steps may be varied in other embodiments, or certain steps may be performed at least in part concurrently with one another rather than serially. Also, one or more of the steps may be repeated periodically, or multiple instances of the methods can be performed in parallel with one another.

Advantageously, as described herein, illustrative embodiments provide techniques for restricting RLOS calls only to allowed countries by analysing MCC values in PLMN IDs to determine whether the country code associated with the current location of user equipment is being used. If differences are found between a stored PLMN ID and an acquired PLMN ID, the methodology includes confirmation procedures to determine whether the PLMN ID is being generated by a fake base station. If it is determined that a fake base station is attempting to develop a RLOS connection, the embodiments advantageously provide mechanisms for terminating the RLOS procedures and alerting users of the potential for fraud.

According to one or more embodiments, in the event that differences are found between a stored network identifier and an acquired network identifier, a user of the user equipment is prompted to confirm whether the first country code indicates a country where the user equipment is located.

In addition, in order to prevent automatic initiation of requests for restricted local operator services, a user of the user equipment is required to affirmatively input a command to initiate the request for access prior to initiating the request. Moreover, a user of the user equipment may be required to affirmatively indicate a country where the user equipment is located prior to initiating the request for access or enabling the user equipment to access the restricted local operator services. Replacement of a stored network identifier with a newly acquired network identifier having a different country code is prevented when a determination of potential fraud has been made. In addition, according to one or more embodiments, such replacement is allowed to occur only after user equipment is powered off and on or returns from out of coverage, allowing for situations where there has been an actual change in location to another country where RLOS may be authorized.

It should therefore again be emphasized that the various embodiments described herein are presented by way of illustrative example only and should not be construed as limiting the scope of the claims. For example, alternative embodiments can utilize different communication system configurations, user equipment configurations, base station configurations, authentication and key agreement protocols, key pair provisioning and usage processes, messaging protocols and message formats than those described above in the context of the illustrative embodiments. These and numerous other alternative embodiments within the scope of the appended claims will be readily apparent to those skilled in the art.

1-30. (canceled)

31. An apparatus comprising:
at least one processor;
at least one memory including computer program code;
the at least one memory and the computer program code being configured to, with the at least one processor, cause the apparatus at least to:
initiate a request for access to restricted local operator services;
acquire a network identifier comprising a first country code;
compare the acquired network identifier with a stored network identifier comprising a second country code;
determine whether the first country code and the second country code are different;
perform at least a first action in response to an affirmative determination; and
perform at least a second action in response to a negative determination;
wherein the at least one processor, the at least one memory and the computer program code are part of user equipment.

32. The apparatus of claim 31, wherein the first action comprises alerting a user of the user equipment of the difference between the first and second country codes.

33. The apparatus of claim 31, wherein the first action comprises prompting a user of the user equipment to confirm whether the first country code indicates a country where the user equipment is located.

34. The apparatus of claim 31, wherein the first action comprises denying access to the restricted local operator services.

35. The apparatus of claim 31, wherein the second action comprises enabling access to the restricted local operator services.

36. The apparatus of claim 31, wherein the at least one memory and the computer program code are further configured to, with the at least one processor, cause the apparatus at least to require a user of the user equipment to affirmatively input a command to initiate the request for access prior to initiating the request.

37. The apparatus of claim 31, wherein the at least one memory and the computer program code are further configured to, with the at least one processor, cause the apparatus at least to require a user of the user equipment to affirmatively indicate a country where the user equipment is located prior to initiating the request for access or enabling the user equipment to access to the restricted local operator services.

38. The apparatus of claim 31, wherein the at least one memory and the computer program code are further configured to, with the at least one processor, cause the apparatus at least to prevent replacement of the stored network identifier comprising the second country code with a network identifier comprising a country code different from the second country code until the user equipment is powered off and on or returns from out of coverage.

39. The apparatus of claim 31, wherein the first and second country codes each comprise a Mobile Country Code (MCC).

40. The apparatus of claim 31, wherein the acquired network identifier corresponds to a Public Land Mobile Network (PLMN).

41. A method comprising:
in accordance with user equipment;
initiating a request for access to restricted local operator services;
acquiring a network identifier comprising a first country code;
comparing the acquired network identifier with a stored network identifier comprising a second country code;
determining whether the first country code and the second country code are different;
performing at least a first action in response to an affirmative determination; and
performing at least a second action in response to a negative determination;
wherein the user equipment comprises a processor and memory configured to execute the above steps.

42. The method of claim 41, wherein the first action comprises alerting a user of the user equipment of the difference between the first and second country codes.

43. The method of claim 41, wherein the first action comprises prompting a user of the user equipment to confirm whether the first country code indicates a country where the user equipment is located.

44. The method of claim 41, wherein the first action comprises denying access to the restricted local operator services.

45. The method of claim 41, wherein the second action comprises enabling access to the restricted local operator services.

46. The method of claim 41, further comprising requiring a user of the user equipment to affirmatively input a command to initiate the request for access prior to initiating the request.

47. The method of claim 41, further comprising requiring a user of the user equipment to affirmatively indicate a country where the user equipment is located prior to initiating the request for access or enabling the user equipment to access to the restricted local operator services.

48. The method of claim 41, further comprising preventing replacement of the stored network identifier comprising the second country code with a network identifier comprising a country code different from the second country code until the user equipment is powered off and on or returns from out of coverage.

49. The method of claim 41, wherein the first and second country codes each comprise a Mobile Country Code (MCC).

50. The method of claim 41, wherein the acquired network identifier corresponds to a Public Land Mobile Network (PLMN).
